(19) United States
(12) Patent Application Publication
(10) Pub. No.: US 2008/0140534 A1
(43) Pub. Date: Jun. 12, 2008

(54) Method and system that provides an incentive for a consumer to participate in a marketing program

(75) Inventor: Stephen A. Muoio, Cross River, NY (US)

Correspondence Address: OHLANDT, GREELEY, RUGGIERO & PERLE, LLP, ONE LANDMARK SQUARE, 10TH FLOOR, STAMFORD, CT, 06901, US

(73) Assignee: TOUCHTONE TECHNOLOGIES, INC.

(21) Appl. No.: 12/001,371

(22) Filed: Dec. 11, 2007

Related U.S. Application Data
(60) Provisional application No. 60/874,162, filed on Dec. 11, 2006.

(51) Int. Cl. G06Q 30/00

(52) U.S. Cl. 705/14

(57) ABSTRACT

There is provided a method that includes (A) receiving a communication from a person, indicating that the person agrees to participate in the method in exchange for compensation, (B) obtaining, via a communication device being employed by the person, data indicative of a geographic location, (C) selecting information for presentation to the person, wherein the selecting considers the geographic location, (D) presenting the information to the person, and (E) providing the compensation to the person.

### FIELD OF THE INVENTION

The present invention relates to advertising and rewards programs, and more specifically, to a technique for providing opt-in, i.e., permission based, advertising via telecommunications services or systems.

### BACKGROUND OF THE INVENTION

Effective ways to reach consumers have long been a concern of business entities. There are numerous reasons why a company may benefit from effective techniques, such as advertising, market research, to communicate with consumers. The benefits of collecting comprehensive demographic data have long been appreciated by companies worldwide. A process of collecting comprehensive demographic data can, for example, collect specific customer telephone data, by tracking originating area code and first three numbers of a phone number (NPA-NXX), and by a location of a destination of a call. Further, it can offer an opt-in option for other requested data.

Existing techniques for reaching consumers to provide advertising and marketing materials and to gather market research data include techniques such as conducting telemarketing surveys, and conducting live surveys at places such as shopping malls. The effectiveness of such surveys is limited, however, by a participant's willingness to participate.

Accordingly, a need exists for an effective technique to allow a company to reach a consumer who is willing to participate in a survey process, or willing to listen to a marketing presentation, or view a visual advertisement or advertising message.

### SUMMARY OF THE INVENTION

There is provided a method that includes (A) receiving a communication from a person, indicating that the person agrees to participate in the method in exchange for compensation, (B) obtaining, via a communication device being employed by the person, data indicative of a geographic location, (C) selecting information for presentation to the person, wherein the selecting considers the geographic location, (D) presenting the information to the person, and (E) providing the compensation to the person.

### BRIEF DESCRIPTION OF THE DRAWINGS

FIG. 1 is a flowchart of a method that involves a consumer participating in a marketing program via telephone.

FIG. 2 is a flowchart of a method that involves the consumer participating in a marketing program via a web site on the Internet.

FIG. 3 is a flowchart of a method that involves a consumer's interaction with an ad content portal.

FIG. 4 is a block diagram of a system 400 that enables a consumer to participate in a marketing program.

### DESCRIPTION OF THE INVENTION

The present invention relates to a technique that provides an incentive for a person that is a potential consumer, referred to herein simply as “the consumer”, to participate in a marketing program being conducted by an advertising entity. The consumer's participation is intended to be voluntary. That is, the consumer is participating because the consumer has affirmatively opted-in to the marketing program. The consumer is compensated for participating in the program. For example, the consumer will receive a reward for reviewing ad content.

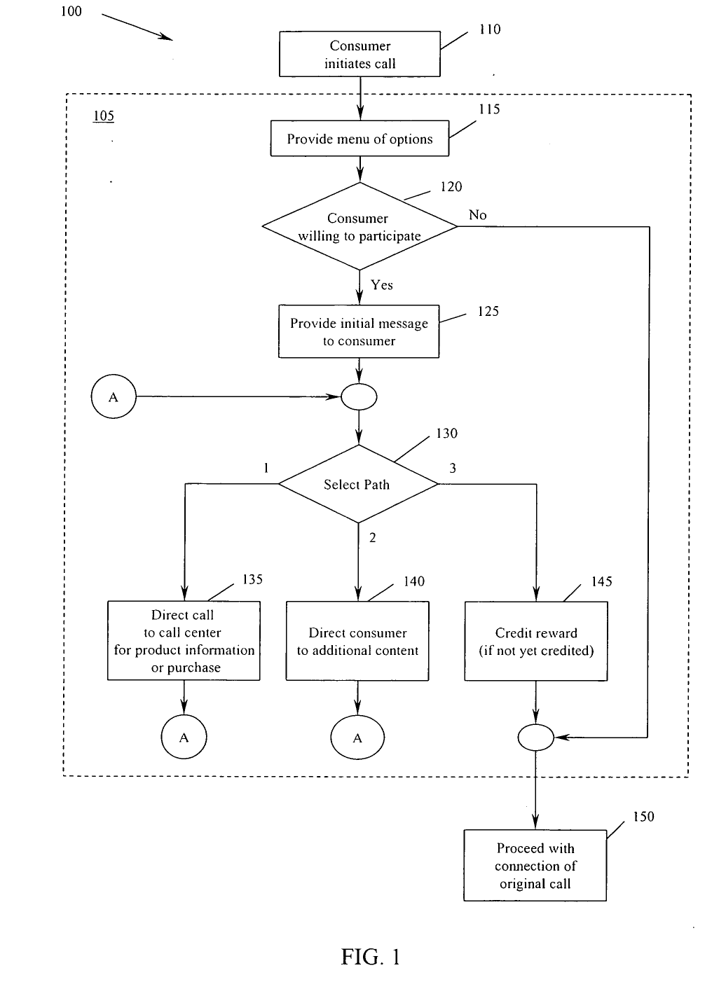

FIG. 1 is a flowchart of a method 100 that involves the consumer participating in a marketing program via telephone. Several steps of method 100 are shown as being bounded by a dashed perimeter, and are designated as a group 105. The steps of group 105 are performed while the consumer is interfacing with the advertising entity.

In method 100, the consumer makes a telephone call. The consumer may wish to make the call to an intended called party, such as a friend of family member, who is not affiliated with the advertising entity. However, in method 100, the consumer, instead of being connected directly to the intended party, is instead first connected to the advertising entity. This connection to the advertising entity may be achieved (A) by the consumer actually dialing a number for the advertising entity, instead of dialing a number of the intended party, or (B) by a system that intercepts a call being placed by the consumer, and redirects the call to the advertising entity. Alternatively, the consumer may not be intending to call a party other than the advertising entity, but instead, affirmatively calls the telecom advertising entity for the purpose of participating in method 100. Method 100 commences with step 110.

In step 110, the consumer initiates the call. The call may be placed via one of several calling systems and various service providers, such as a competitive local exchange carrier (CLEC), a pre-paid calling card provider, a cellular or pager service provider, a pay-phone provider, or other provider of communication services. From step 110, method 100 progresses to step 115.

In step 115, the consumer is offered a menu of options that invite the consumer to participate in a program to listen to some form of content, such as advertising content, in exchange for a reward or other form of compensation. Examples of such content are an advertisement of a product, a promotional message, an interactive survey, informational messages, and a request for the consumer to provide demographic data. Any number of various message contents could be presented to the consumer. For example, the message may be an offer for the consumer to listen to an advertisement in exchange for a reward.

The reward offered to the consumer could be one of a number of possible reward options. For example, the reward could be a reduced rate on the telephone call that the consumer is about to place, or points usable for future calls. In a case where a pre-paid calling card is charged a fee for each call, such rewards may provide a particularly enticing opportunity for the consumer. Alternatively, additional calling minutes could be applied to the consumer's pre-paid card as a reward. Other types of reward offers could include a discount on a particular advertised product, a credit towards a point system reward product offered by a particular retailer, or other rewards programs offered by product manufacturers or retailers.

From step 115, method 100 progresses to step 120.

In step 120, the consumer indicates whether the consumer is willing to participate in the program. The consumer responds via keypad entry or voice command to accept or reject the offer to listen to the advertisement and receive a reward. If the customer is willing to participate, then method 100 progresses to step 125. If the customer is not willing to participate, then method 100 progresses to step 150.

In step 125, a voice prompt plays a voice message inviting the consumer to provide identification (ID) attributes for identifying the consumer. Examples of such attributes include the consumer's telephone number, the consumer's email address, and home address. The message may also request other demographic information, such as the consumer's age and gender. Additionally, data is obtained from the consumer's telephone, where the data is indicative of a geographic location. For example, the geographic location could be derived from a telephone number of the call being placed on the telephone, or could be a location from which the call is being made.

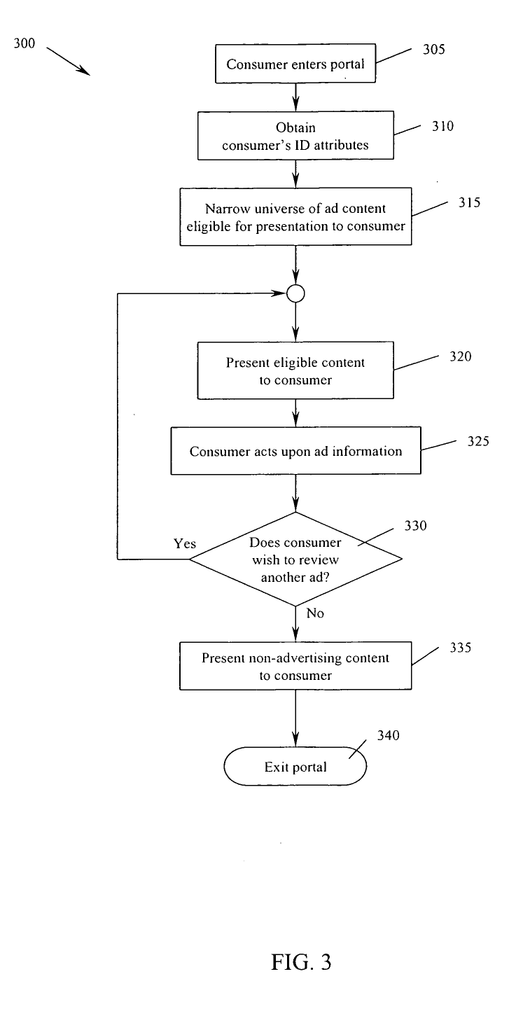

The ID attributes and other demographic information will be used by the advertising entity to select ads that may be of interest to the consumer, or to select ads that an advertiser wishes to present to a consumer having a profile similar to that of the consumer. The presentation of the ad content is accomplished by way of the consumer entering an ad content portal. Additional details of such a portal are discussed below, in association with FIG. 3. Alternatively, the voice message could be provided without requiring consumer interaction. From step 125, method 100 progresses to step 130.

In step 130, the consumer is provided various options for proceeding, and the consumer selects from among the options. The options are:
(1)—learn more about an advertised product;
(2)—participate in an additional reward program; or
(3)—proceed with the original call.

If the consumer selects option (1), then method 100 progresses to step 135. If the consumer selects option (2), then method 100 progresses to step 140. If the consumer selects option (3), then method 100 progresses to step 145.

In step 135, the call is directed to a call center for a retailer where the consumer can learn more about the advertised product, and purchase the advertised product. The call center may be either automated or manned by a live operator. From step 135, method returns to step 130.

In step 140, the consumer is presented with additional content regarding reward options. For example, the consumer may be invited to listen to other messages or content to accumulate additional rewards. Further examples include (A) using an interactive voice response system to gather personal data such as name address, age, gender, and ethnicity, in return for additional rewards, (B) providing entry into a promotional sweepstakes, (C) providing access to the consumer's reward account to allow the consumer to check a balance of reward points, and (D) redemption of reward points. The rewards may be subject to a predetermined limit. The presentation of the ad content is accomplished by way of the consumer entering an ad content portal. Additional details of such a portal are discussed below, in association with FIG. 3. From step 140, method 100 returns to step 130.

In step 145, since the consumer has elected to not pursue any further reward options, and wishes to proceed with the original call, the is awarded the reward earned, if the reward has not yet been credited to the consumer. The reward can be provided in numerous ways depending upon the reward, including providing an instantaneous adjustment to a balance of a calling card being used, providing an instantaneous reduction in a rate applied to the present call, or providing a promotional code that the consumer can enter into a web site to redeem merchandise or a service. Additionally, the reward can be provided via email or postal mail, e.g., in the case of a promotional code, which further allows inclusion of additional marketing materials. From step 145, method 100 progresses to step 150.

In step 150, a connection is made to enable the consumer to proceed with the original call.

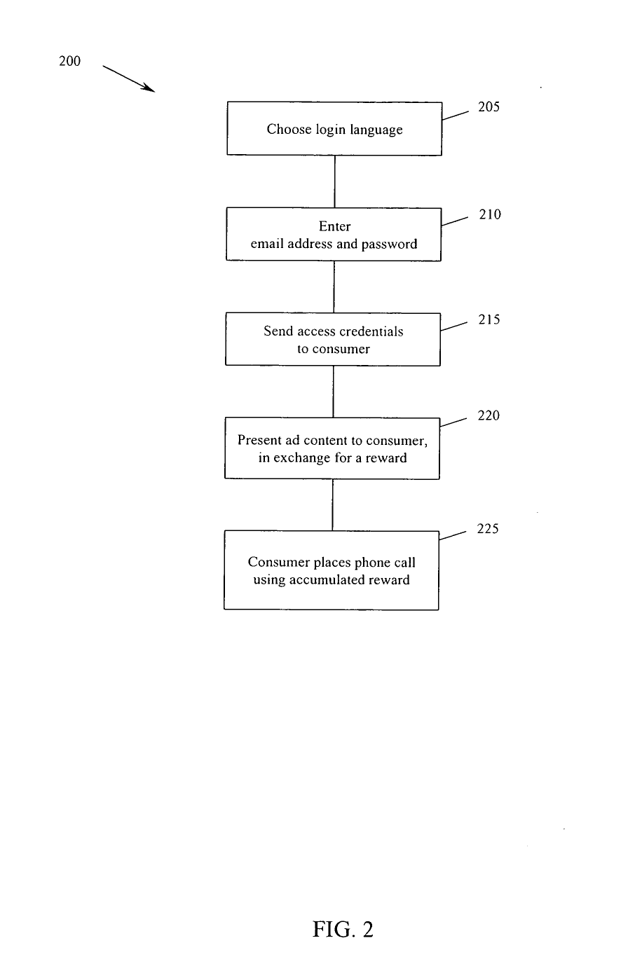

FIG. 2 is a flowchart of a method 200 that involves the consumer participating in a marketing program via an interface device that accesses a web site on the Internet. Method 200 commences with step 205.

In step 205, the consumer selects a language in which to conduct a login and interaction with the web site. From step 205, method 100 proceeds to step 210.

In step 210, the consumer logs in, supplying identification attributes that can be used to identify the consumer, such as, for example, an email address and a password. Additionally, data is obtained from the consumer's interface device, where the data is indicative of a geographic location. For example, an Internet protocol (IP) address of the interface device may be indicative of a location of the interface device.

Method 200 also contemplates inviting the consumer to provide other identification attributes for identifying the consumer. Examples of such attributes include the consumer's telephone number and home address. The message may also request other demographic information, such as the consumer's age and gender. The ID attributes and other demographic information will be used by the advertising entity to select ads that may be of interest to the consumer, or to select ads that an advertiser wishes to present to a consumer having a profile similar to that of the consumer. From step 210, method 200 proceeds to step 215.

In step 215, the consumer is sent, to the email address supplied instep 210, an email containing credentials, such as a personal identification number (PIN) and an access number. The credentials will be presented by the consumer, for example, when the consumer wishes to place a telephone call using accumulated rewards. From step 215, method 200 progresses to step 220.

In step 220, the consumer is presented with ad content on the web site, and in exchange for the consumer viewing the ad content, the consumer is given a reward. One of many possible rewards is to credit the consumer points usable for placing telephone calls. Rewards are credited to the consumer in real time as the consumer views the ad content. The presentation of the ad content is accomplished by way of the consumer entering an ad content portal. Additional details of such a portal are discussed below, in association with FIG. 3. From step 220, method 200 progresses to step 225.

In step 225, a consumer places a telephone call, using the rewards accumulated in step 220 wholly or partly to offset the cost of the telephone call. Alternatively, the rewards could be used to allow the consumer access to the Internet for some period of time, or for other merchandise or services.

FIG. 3 is a flowchart of a method 300 that involves a consumer's interaction with an ad content portal. Method 300 may be entered, for example, from method 100, step 125 or step 140, or from method 200 step 220. Method 300 commences with step 305.

In step 305, the consumer enters the portal to receive ad content. If the consumer is presently using a telephone, e.g., method 100, then the portal is an audio interface that the consumer accesses via the telephone. If the consumer is presently using the Internet, e.g., method 200, then the portal is a web interface that the consumer accesses via the Internet. From step 305, method 300 progresses to step 310.

In step 310, portal logic obtains the consumer's identification attributes and other demographic data. In this regard, see method 100, step 125, and method 200, step 210. From step 305, method 300 progresses to step 315.

In step 315, portal logic narrows the universe of advertising content eligible for presentation to the consumer. That is, eligible content is a subset of the set of all advertising content available via the portal. The selection of eligible content considers the geographic location that was obtained from the communication device that the consumer is using. Thus, the selected content will have some relevance to the geographic location. For example, if the consumer is placing the call from Connecticut, the content could be an advertisement for a store in Connecticut. However, the content need not be limited to an advertisement for a product or service in the geographic location. The geographic location could be used to discern other characteristics of content that might be of interest to the consumer. For example, if the consumer is calling France, the content could be an advertisement in French.

As mentioned above, in the case of the consumer using a telephone, as in method 100, geographic location could be derived from a telephone number of the call being placed on the telephone, or could be a location from which the call is being made. In a case of the consumer using an interface device to access the Internet, as in method 200, the Internet protocol (IP) address of the interface device may be indicative of a location of the interface device. This narrowing of advertising content can also be based on the consumer's identification attributes and other demographic data. If the consumer has had a prior encounter with the advertising entity, for example by having previously interacted with the present portal, the narrowing of content can be based on the consumer's past behavior during the interaction with the portal.

Also, if the consumer is accessing the Internet via an interface device, an IP address of the interface device and an email address can be utilized as an identifier. Having such an identifier is useful to correlate a web site visitor with a variety of collected data pertinent to that visitor. In turn, a correlation of a web site visitor, i.e. the consumer, with a variety of collected data is used by the portal logic for the purpose of preferentially selecting advertising content for presentation to the consumer. For instance, a web site visitor could be tied to telephone calling data. The telephone calling data, in turn, might be indicative of (i) what language a caller speaks, based on call origination point or destination, (ii) what hours a caller is awake, (iii) a caller's daily or seasonal calling habits, or (iv) who the caller knows. Additionally, call origination data can be used to deduce a caller's location, and are useful for presentation of locality-specific advertisements.

The consumer could also be associated to a particular purchasing history, or history of previous advertising content reviewed. Portal logic is capable of taking into account the time of day of purchases, season of purchases, and other temporal information.

Portal logic can also process customer-supplied data to screen users who have provided false or misleading data. But even false data can provide some insight into the consumer's state of mind. For example, if the portal logic suspects that the consumer has provided false identification information, method 300 may consider presenting the consumer with content regarding Internet anonymity.

From step 315, method 300 progresses to step 320.

In step 320, eligible advertising content is presented to the consumer. Presentation to the consumer is performed in a way appropriate to the route through which the consumer has entered the portal. For example, a consumer who has entered the portal via a web site will be presented with textual and/or graphical content viewable in a web browser. A consumer who has entered the portal using a telephone will be presented with audio content. From step 320, method 300 progresses to step 325.

In step 325, the consumer acts upon advertising information, that is, content, presented to the consumer in step 320. For example, the consumer may choose to receive more information about particular content, skip further content, or proceed to further steps unrelated to receiving advertising content. From step 325, method 300 progresses to step 330.

In step 330, method 300 considers the consumer's interaction in step 325. If the consumer elected to receive further advertising content, then method 300 branches back to step 320. If the consumer elects to not to receive further advertising content, then method 300 proceeds to step 335.

In step 335, the consumer is presented with non-advertising content, for example an interface to check the reward balance. From step 335, method 300 progresses to step 340.

In step 340, method 300 exits the portal, and returns to the process from which it was invoked, i.e., method 100 or method 200.

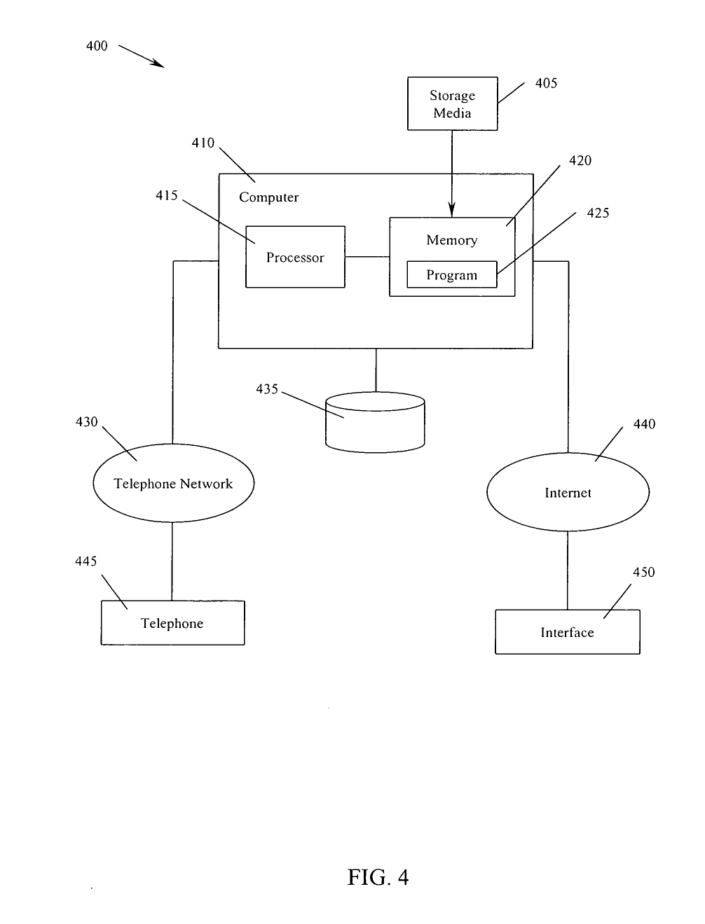

FIG. 4 is a block diagram of a system 400 that enables a consumer to participate in a marketing program. System 400 includes a computer 410 that, in turn, includes a processor 415 with an associated memory 420. Computer 410 is coupled to a database 435, a telephone network 430 and the Internet 440.

Database 435 is a storage device, for storage of ad content and other information for possible presentation to the consumer. Database 435 can also serve as a repository for consumer identification information and other information about the consumer, as described for methods 100, 200 and 300.

Memory 420 contains instructions for controlling operation of processor 415. More specifically, memory 420 contains a program module 425 that contains instructions that when executed by processor 415, cause processor 415 to perform methods 100, 200 and 300, described above. In this regard, a consumer uses either a telephone 445 to communicate with computer 410 via telephone network 430, or uses an interface to communicate with computer 410 via the Internet 440.

With regard to program module 425, the term “module” is used herein to denote a functional operation that may be embodied either as a stand-alone component or as an integrated configuration of a plurality of sub-ordinate components.

Although system 400 is described herein as having program 425 installed into memory 420, program 425 can be tangibly embodied on an external computer-readable storage media 405 for subsequent loading into memory 420. Storage media 405 can be any storage media, including, but not limited to, a floppy disk, a compact disk, a magnetic tape, a read only memory, or an optical storage media. Program 425 could also be embodied in a random access memory, or other type of electronic storage, located on a remote storage system and coupled to memory 420.

Moreover, although program 425 is described herein as being installed in memory 420, and therefore being implemented in software, it could be implemented in any of hardware, firmware, software, or a combination thereof.

System 400 can provide the consumer with both audio and visual content. Examples of such content include advertising messages, interactive surveys, promotional alerts, and the content may be offered by recordings or by live operators. Many phones, cellular phones for example, have display capabilities that allow for visual content such as text messages, pictures or movies. Using these display capabilities, visual content can be provided to the consumer via the telephone. Thus, visual content can be provided either oil the web site or on a phone having a display capability.

Additionally, a phone may have the ability to provide Internet access. System 400 can direct the consumer to a web site such as an advertiser's web site or the advertising entity's mail portal. The use of a web site also allows for access at a later time by the consumer. For example, the consumer may review an ad for a product, and then later decide to purchase the product, and can do so by accessing the web site. Alternatively, the web site may provide an outlet for the consumer to check reward balances and see newly published ad campaigns, special offers and special advertisements.

The content messages can be updated, modified, or changed as often as desired. Content can be changed based upon time, e.g., weekly, number of times played, e.g., after 1000 accesses, geographic data, e.g., calls from a particular location trigger a different set of content, or any other criteria desired by the advertiser. This flexibility in content adjustment provides a significant advantage over existing advertising systems particularly due to the opt-in nature of the program.

System 400 may also be employed in conjunction with other forms of advertising. For example, the faces of prepaid calling cards can be printed with advertisements. Such advertisements can be correlated to the advertisements provided via system 400. For example, an advertiser might have an advertisement on the prepaid card, and calls made using that particular card can be subjected to audio and/or visual content regarding that advertiser's products. Inserts may be included in the consumer's phone bill that follow use of system 400, e.g., in the bill from the cellular provider in the case of cell phone access. Such inserts are also an additional channel for providing rewards, for example, coupons. Audio reinforcements can be correlated with the customer's viewing of a specific ad. For example, if the consumer chooses to view an ad for an advertiser's soap, an audio ad for the advertiser's soap can be played when the consumer places a phone call.

System 400 provides benefits for both of the advertiser and the consumer. System 400 can help the advertiser to identify its target customer after a consumer opts for the advertiser's ad or promotion. Advertisers will be able to acquire business from target customers that will come to the advertiser to redeem points earned. Advertisers can adapt their key messages to the culture of each customer-type. Advertisers may change ads in real-time. Consumers can interact with the advertiser by selecting “push-button” options available during and/or after the audio ad (for example: “Please, press [2] to connect with the advertiser”). The consumer chooses the ad the consumer wants to review, specifying interest in that product or service. Also, the consumer will be presented ads that are of more particular interest to the consumer, and hopefully, will be presented with few ads that are of little or now interest to the consumer.

Additionally, system 400 can be employed in geographic locations that encourage participation. For example, payphones in a mall parking lot may help local advertisers to promote specials in a local store in that very mall, announce giveaways, offer coupons for redemption in a local store, etc. These are voice blast, location specific ads that target specific products and services in a specific geographic area.

System 400 creates a mutually advantageous scenario for telecom providers, advertisers and customers by (1) helping telecommunication carriers obtain higher efficiencies, identify areas of growth and develop expansion strategies leading to additional streams of revenue, in order to overcome the hurdle of further commoditization and growing competition from newly reformed telecom conglomerates; (2) lowering telephone rates or offering free phone calls for the telephone-addicts and/or increasing talk-time for the money; and (3) developing a new, innovative and efficient medium for all types of advertisers.

A variety of modifications to the embodiments described will be apparent to those skilled in the art from the disclosure provided herein. For example, steps associated with 100, 200 and 300 can be performed in any suitable order, unless otherwise specified or dictated by the steps themselves. Thus, the present invention may be embodied in other specific forms without departing from the spirit or essential attributes of the invention. Such modifications are contemplated as falling within the scope of the invention described herein.

What is claimed is:

1. A method comprising:
receiving a communication from a person, indicating that the person agrees to participate in said method in exchange for compensation;
obtaining, via a communication device being employed by the person, data indicative of a geographic location;
selecting information for presentation to said person, wherein said selecting considers said geographic location;
presenting said information to said person; and
providing said compensation to said person.

2. The method of claim 1,
wherein said communication device is a telephone, and
wherein said geographic location is derived from a telephone number of a call being placed on said telephone.

3. The method of claim 1,
wherein said communication device is a telephone, and
wherein said geographic location is a location from which a call is being made on said telephone.

4. The method of claim 1,
wherein said communication device is coupled to the Internet, and
wherein said geographic location is derived from an Internet protocol (IP) address associated with said communication device.

5. The method of claim 1, wherein said compensation comprises a usage of a communication service.

6. The method of claim 5, wherein said communication service is selected from the group consisting of telephone service and Internet service.

7. The method of claim 1,
wherein said communication device is a telephone, and
wherein said compensation comprises enabling a call to be made via said telephone.

8. The method of claim 1, further comprising:
obtaining demographic information about said person,
wherein said selecting also considers said demographic information.

9. A system comprising:
a module that receives a communication from a person, indicating that the person agrees to participate in a method in exchange for compensation;
a module that obtains, via a communication device being employed by the person, data indicative of a geographic location;
a module that selects information for presentation to said person, wherein said selecting considers said geographic location;
a module that presents said information to said person; and
a module that provides said compensation to said person.

10. The system of claim 9,
wherein said communication device is a telephone, and
wherein said geographic location is derived from a telephone number of a call being placed on said telephone.

11. The system of claim 9,
wherein said communication device is a telephone, and
wherein said geographic location is a location from which a call, is being made on said telephone.

12. The system of claim 9,
wherein said communication device is coupled to the Internet, and
wherein said geographic location is derived from an Internet protocol (IP) address associated with said communication device.

13. The system of claim 9, wherein said compensation comprises a usage of a communication service.

14. The system of claim 13, wherein said communication service is selected from the group consisting of telephone service and Internet service.

15. The system of claim 9
wherein said communication device is a telephone, and
wherein said compensation comprises enabling a call to be made via said telephone.

16. The system of claim 9, further comprising:
obtaining demographic information about said person,
wherein said selecting also considers said demographic information.

17. A storage media, comprising a program encoded thereon that is executable in a processor to perform a method that includes:
receiving a communication from a person, indicating that the person agrees to participate in said method in exchange for compensation;
obtaining, via a communication device being employed by the person, data indicative of a geographic location;
selecting information for presentation to said person, wherein said selecting considers said geographic location;
presenting said information to said person; and
providing said compensation to said person.
